(19) United States
(12) Patent Application Publication
(10) Pub. No.: US 2014/0320395 A1
(43) Pub. Date: Oct. 30, 2014

(54) ELECTRONIC DEVICE AND METHOD FOR ADJUSTING SCREEN ORIENTATION OF ELECTRONIC DEVICE

(71) Applicant: CHIUN MAI COMMUNICATION SYSTEMS, INC., New Taipei (TW)

(72) Inventor: HSIAO-CHENG CHI, New Taipei (TW)

(73) Assignee: CHIUN MAI COMMUNICATION SYSTEMS, INC., New Taipei (TW)

(21) Appl. No.: 14/261,437

(22) Filed: Apr. 25, 2014

(30) Foreign Application Priority Data
Apr. 29, 2013 (TW) 102115195

(51) Int. Cl. G06T 3/60; G06F 3/01

(52) U.S. Cl. CPC G06T 3/60; G06F 3/013
USPC 345/156

(57) ABSTRACT

In a method for adjusting screen orientation of an electronic device, an orientation of the electronic device is detected using a gravity sensor of the electronic device. If the electronic device is rotated by a predetermined angle, a facial image of a user in front of the electronic device is captured by a camera of the electronic device, eyes of the user in the facial image are detected. If the eyes of the user in the facial image are in a vertical direction, the screen orientation of the electronic device is adjusted to a landscape screen orientation. If the eyes of the user in the facial image are in a horizontal direction, the screen orientation of the electronic device is adjusted to a portrait screen orientation.

### BACKGROUND

1. Technical Field

The embodiments of the present disclosure relate to screen control systems and methods, and particularly to an electronic device and a method for adjusting a screen orientation of the electronic device.

2. Description of Related Art

Electronic device, such as a mobile phone, may be equipped with a gravity sensor. The gravity sensor detects an orientation of the electronic device. When the electronic device is rotated, a screen orientation of the electronic device may be adjusted, keeping contents on a display screen of the electronic device horizontal and easily viewable. However, the adjusted screen orientation may be unwanted in some cases. For example, when a user sits on a bed, the user may choose to have a portrait orientation for the screen. But when the user changes position to lie on side in the bed, the screen orientation of the electronic device might have been switched from portrait to landscape even though the portrait view is still desired by the user.

### BRIEF DESCRIPTION OF THE DRAWINGS

FIG. 1 shows one embodiment of an electronic device.

FIG. 2 is a block diagram of one embodiment of function modules of a screen adjustment system of the electronic device in FIG. 1.

FIG. 3 is a flowchart of one embodiment of a method for adjusting a screen orientation of the electronic device in FIG. 1.

FIG. 4 illustrates one embodiment of capturing a facial image using a camera included in the electronic device of FIG. 1.

FIG. 5 is one embodiment illustrating a coordinate system of a display screen included in the electronic device of FIG. 1.

FIGS. 6A-6B are embodiments illustrating coordinates of eyes of a user in a facial image.

FIGS. 7A-7B are embodiments illustrating a landscape screen orientation and a portrait screen orientation of the electronic device in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives.

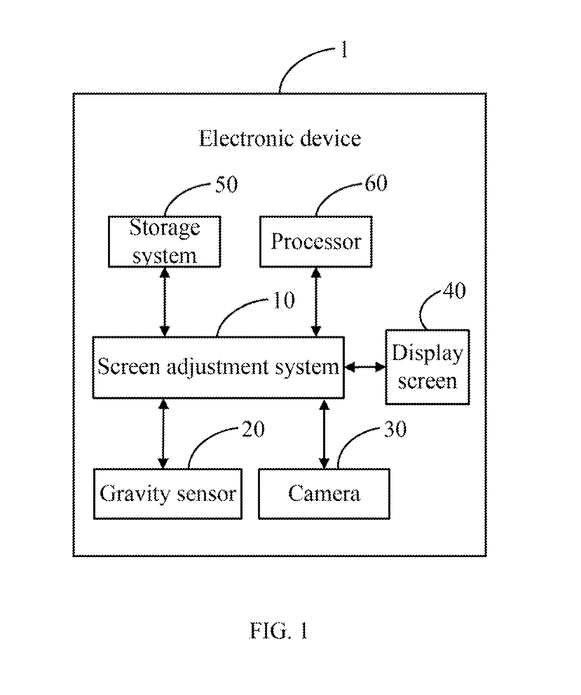

FIG. 1 shows one embodiment of an electronic device 1. The electronic device 1 includes a screen adjustment system 10, a gravity sensor 20, a camera 30, and a display screen 40. The gravity sensor 20 detects an orientation of the electronic device 1. The camera 30 may be a front facing camera, which captures a facial image of a user in front of the electronic device 1. The screen adjustment system 10 adjusts a screen orientation of the electronic device 1 according to the orientation of the electronic device 1 and the facial image of the user. The screen orientation of the electronic device 1 can be portrait or landscape. The electronic device 1 may be a mobile device, such as a mobile phone or a tablet computer. FIG. 1 is only one example of the electronic device 1, and other examples may comprise more or fewer components than those shown in the embodiment, or have a different configuration of the various components.

The electronic device 1 may further include a storage system 50 and at least one processor 60. The storage system 50 can be a dedicated memory, such as EPROM, a hard disk drive (HDD), or flash memory. In some embodiments, the storage system 50 can also be an external storage device, such as an external hard disk, a storage card, or other data storage medium. The at least one processor 60 can be a central processing unit (CPU), a microprocessor, or other suitable data processor chip that performs various functions of the electronic device 1.

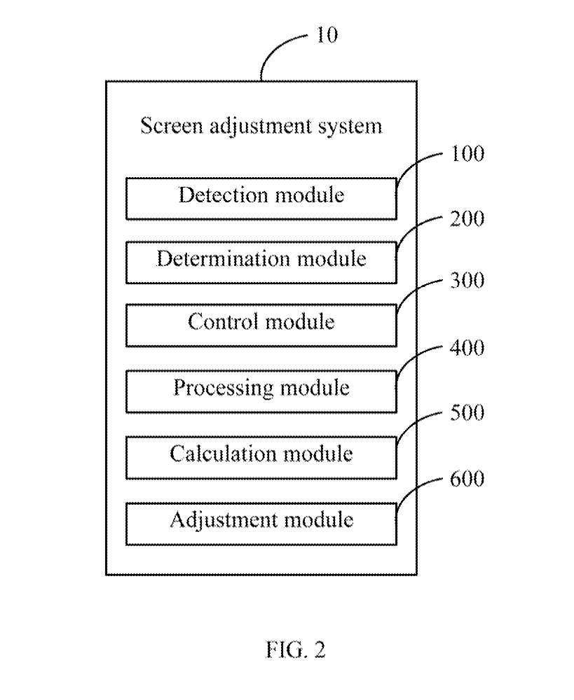

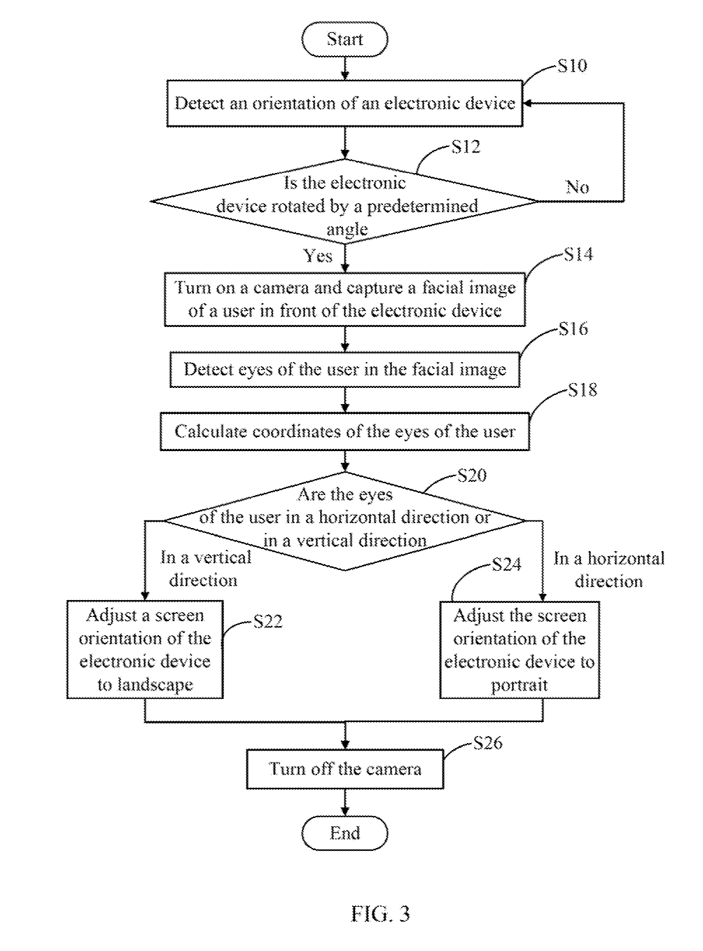

FIG. 2 is a block diagram of one embodiment of function modules of the screen adjustment system 10 shown in FIG. 1. The screen adjustment system 10 includes a detection module 100, a determination module 200, a control module 300, a processing module 400, a calculation module 500, and an adjustment module 600. The modules 100-600 may comprise computerized codes in the form of one or more computer-readable programs that are stored in a non-transitory computer-readable medium, such as the storage system 50. The computerized codes include instructions that are executed by the at least one processor 60, to provide the aforementioned functions of the screen adjustment system 10. A detailed description of the functions of the modules 100-600 is given below in reference to FIG. 3.

FIG. 3 is a flowchart of one embodiment of a method for adjusting a screen orientation of the electronic device 1 in FIG. 1. Depending on the embodiment, additional steps may be added, others removed, and the ordering of the steps may be changed.

In step S10, the detection module 100 detects an orientation of the electronic device 1 using the gravity sensor 20. The orientation of the electronic device 1 may be represented by angles of the electronic device 1 in a three dimensional space.

In step S12, the determination module 200 determines whether the electronic device 1 is rotated by a predetermined angle according to the orientation of the electronic device. For example, the determination module 200 determines whether the electronic device 1 is rotated left or right by an angle more than 45 degrees. If the electronic device 1 is rotated by the predetermined angle, the process goes to step S14. Otherwise, if the electronic device 1 is not rotated by the predetermined angle, the process returns to step S10.

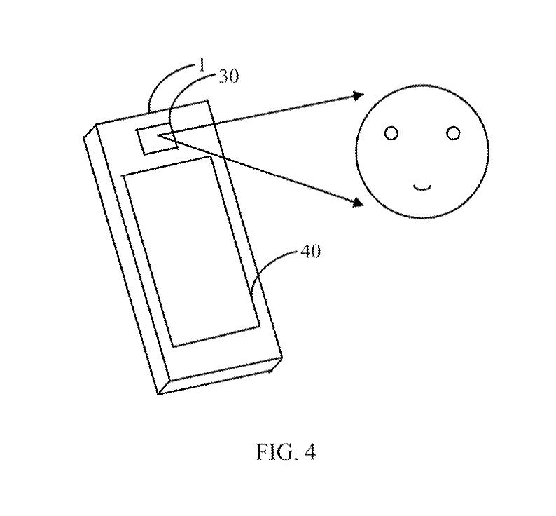

In step S14, the control module 300 turns on the camera 30 and controls the camera 30 to capture a facial image of a user in front of the electronic device 1. FIG. 4 illustrates one embodiment of capturing a facial image using the camera 30.

In step S16, the processing module 400 detects eyes of the user in the facial image. In one embodiment, the processing module 400 recognizes a face region of the user in the facial image, and recognizes the eyes of the user from the face region. The processing module 400 may recognize the face region of the user in the facial image using a facial recognition algorithm. The facial recognition algorithm may be a feature-based algorithm, a neural networks algorithm, an elastic graph matching algorithm, or a support vector machines algorithm. In this embodiment, the processing module 400 recognizes the face region of the user in the facial image using a feature-based algorithm, and recognizes the eyes of the user from the face region using a feature vector algorithm.

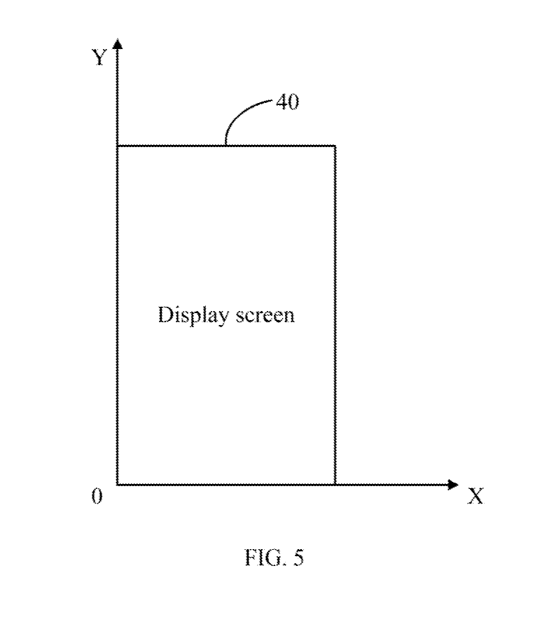

In step S18, the calculation module 500 calculates coordinates of the eyes of the user in the facial image. The coordinates of the eyes of the user in the facial image may be coordinates in a coordinate system of the display screen 40. FIG. 5 is one embodiment illustrating a coordinate system of the display screen 40. An origin of the coordinate system is located at the bottom left corner of the display screen 40. An x-axis of the coordinate system is along a bottom edge of the display screen 40. A y-axis of the coordinate system is along a left edge of the display screen 40.

In step S20, the determination module 200 determines whether the eyes of the user in the facial image are in a horizontal direction or in a vertical direction according to the coordinates of the eyes of the user in the facial image. In one embodiment with respect to FIG. 5, if a line connecting the eyes of the user in the facial image is perpendicular or approximately perpendicular to the x-axis (i.e., the bottom edge of the display screen 40), the eyes of the user in the facial image are deemed to be in the vertical direction. If the line connecting the eyes of the user in the facial image is parallel or approximately parallel to the x-axis, the eyes of the user in the facial image are deemed to be in the horizontal direction. Where the line connecting the eyes of the user in the facial image is approximately perpendicular to the x-axis, this denotes that an angle between the eyes-line and the y-axis is less than a first preset threshold (e.g., 10 degrees). Similarly, where the line connecting the eyes of the user in the facial image is approximately parallel to the x-axis, this denotes that an angle between the line connecting the eyes of the user in the facial image and the x-axis is less than a second preset threshold (e.g., 10 degrees).

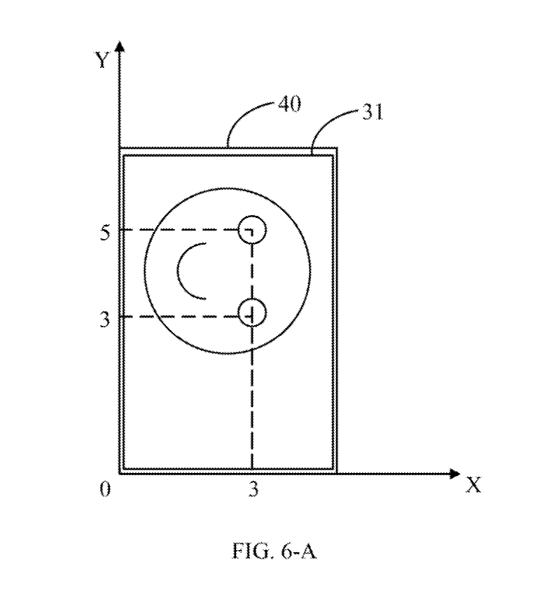

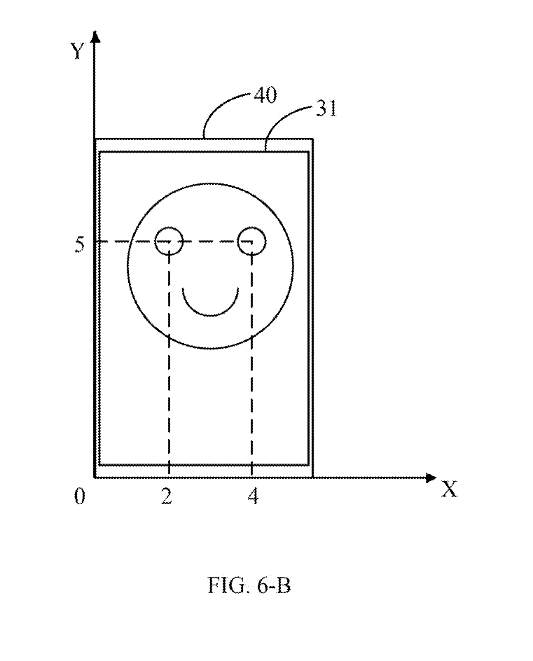

In one example with respect to FIG. 6-A, coordinates of the left eye of the user are (3, 5) and coordinates of the right eye of the user are (3, 3), the line connecting the eyes of the user in a facial image 31 is perpendicular to the x-axis. Therefore, the eyes of the user in the facial image 31 are determined to be in the vertical direction. In another example with respect to FIG. 6-B, coordinates of the left eye of the user are (2, 5) and coordinates of the right eye of the user are (4, 5), the line connecting the eyes of the user in the facial image 31 is parallel to the x-axis. Therefore, the eyes of the user in the facial image 31 are determined to be in the horizontal direction.

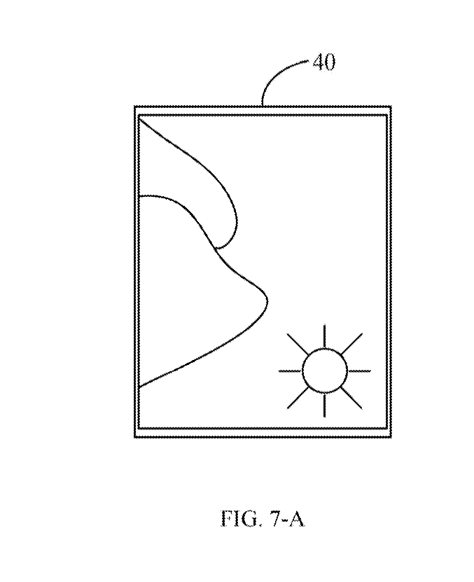

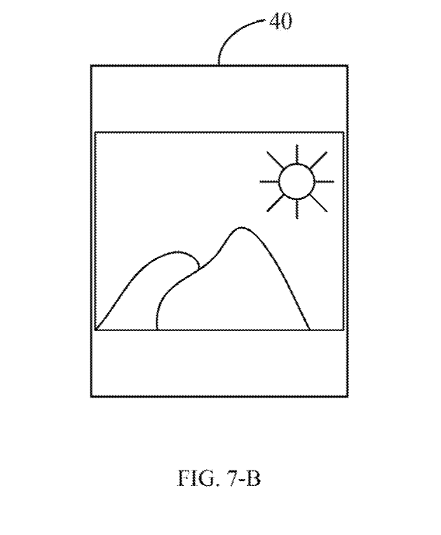

If the eyes of the user in the facial image are in a vertical direction, in step S22, the adjustment module 600 adjusts the screen orientation of the electronic device 1 to a landscape screen orientation. FIG. 7A is one embodiment illustrating a landscape screen orientation of the electronic device 1.

If the eyes of the user in the facial image are in a horizontal direction, in step S24, the adjustment module 600 adjusts the screen orientation of the electronic device 1 to a portrait screen orientation. FIG. 7B is one embodiment illustrating a portrait screen orientation of the electronic device 1.

In step S26, the control module 300 turns off the camera 30 when the electronic device 1 is powered off or in a stand-by state.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method for adjusting screen orientation of an electronic device, the electronic device comprising a gravity sensor and a camera, the method comprising:
detecting an orientation of the electronic device using the gravity sensor, and determining whether the electronic device is rotated by a predetermined angle according to the orientation of the electronic device;
controlling the camera to capture a facial image of a user in front of the electronic device upon condition that the electronic device is rotated by the predetermined angle;
detecting eyes of the user in the facial image;
calculating coordinates of the eyes of the user in the facial image;
determining whether the eyes of the user in the facial image are in a horizontal direction or in a vertical direction according to the coordinates of the eyes of the user in the facial image;
adjusting the screen orientation of the electronic device to a landscape screen orientation upon condition that the eyes of the user in the facial image are in a vertical direction; and
adjusting the screen orientation of the electronic device to a portrait screen orientation upon condition that the eyes of the user in the facial image are in a horizontal direction.

2. The method of claim 1, wherein the predetermined angle is an angle more than 45 degrees.

3. The method of claim 1, wherein the eyes of the user in the facial image are detected by recognizing a face region of the user in the facial image, and recognizing the eyes of the user from the face region.

4. The method of claim 1, wherein the eyes of the user in the facial image are determined in the vertical direction if a line connecting the eyes of the user in the facial image is perpendicular or approximately perpendicular to a bottom edge of the facial image.

5. The method of claim 1, wherein the eyes of the user in the facial image are determined in the horizontal direction if a line connecting the eyes of the user in the facial image is parallel or approximately parallel to a bottom edge of the facial image.

6. An electronic device, comprising:
a gravity sensor;
a camera;
a display screen;
at least one processor; and
a storage system storing a computer-readable program comprising a plurality of instructions, which when executed by the at least one processor, causes the at least one processor to perform operations comprising:
detecting an orientation of the electronic device using the gravity sensor, and determining whether the electronic device is rotated by a predetermined angle according to the orientation of the electronic device;
controlling the camera to capture a facial image of a user in front of the electronic device upon condition that the electronic device is rotated by the predetermined angle;
detecting eyes of the user in the facial image;
calculating coordinates of the eyes of the user in the facial image;
determining whether the eyes of the user in the facial image are in a horizontal direction or in a vertical direction according to the coordinates of the eyes of the user in the facial image;
adjusting the screen orientation of the electronic device to a landscape screen orientation upon condition that the eyes of the user in the facial image are in a vertical direction; and
adjusting the screen orientation of the electronic device to a portrait screen orientation upon condition that the eyes of the user in the facial image are in a horizontal direction.

7. The electronic device of claim 6, wherein the predetermined angle is an angle more than 45 degrees.

8. The electronic device of claim 6, wherein the eyes of the user in the facial image are recognized by recognizing a face region of the user in the facial image, and recognizing the eyes of the user from the face region.

9. The electronic device of claim 6, wherein the eyes of the user in the facial image are determined in the vertical direction if a line connecting the eyes of the user in the facial image is perpendicular or approximately perpendicular to a bottom edge of the facial image.

10. The electronic device of claim 6, wherein the eyes of the user in the facial image are determined in the horizontal direction if a line connecting the eyes of the user in the facial image is parallel or approximately parallel to a bottom edge of the facial image.

11. A non-transitory computer-readable storage medium storing a set of instructions, the set of instructions capable of being executed by a processor of an electronic device to implement a method for adjusting screen orientation of an electronic device, the electronic device comprising a gravity sensor and a camera, the method comprising:
detecting an orientation of the electronic device using the gravity sensor, and determining whether the electronic device is rotated by a predetermined angle according to the orientation of the electronic device;
controlling the camera to capture a facial image of a user in front of the electronic device upon condition that the electronic device is rotated by the predetermined angle;
detecting eyes of the user in the facial image;
calculating coordinates of the eyes of the user in the facial image;
determining whether the eyes of the user in the facial image are in a horizontal direction or in a vertical direction according to the coordinates of the eyes of the user in the facial image;
adjusting the screen orientation of the electronic device to a landscape screen orientation upon condition that the eyes of the user in the facial image are in a vertical direction; and
adjusting the screen orientation of the electronic device to a portrait screen orientation upon condition that the eyes of the user in the facial image are in a horizontal direction.

12. The storage medium of claim 11, wherein the predetermined angle is an angle more than 45 degrees.

13. The storage medium of claim 11, wherein the eyes of the user in the facial image are recognized by recognizing a face region of the user in the facial image, and recognizing the eyes of the user from the face region.

14. The storage medium of claim 11, wherein the eyes of the user in the facial image are determined in the vertical direction if a line connecting the eyes of the user in the facial image is perpendicular or approximately perpendicular to a bottom edge of the facial image.

15. The storage medium of claim 11, wherein the eyes of the user in the facial image are determined in the horizontal direction if a line connecting the eyes of the user in the facial image is parallel or approximately parallel to a bottom edge of the facial image.
